(19) United States
(12) Patent Application Publication
(10) Pub. No.: US 2024/0249609 A1
(43) Pub. Date: Jul. 25, 2024

(54) PROXIMITY SENSOR THREAT WARNING PERSONAL SECURITY SYSTEM AND METHOD

(71) Applicant: Michael P. Chamberlain, Shawnee, KS (US)

(72) Inventor: Michael P. Chamberlain, Shawnee, KS (US)

(21) Appl. No.: 18/422,630

(22) Filed: Jan. 25, 2024

Related U.S. Application Data
(60) Provisional application No. 63/441,102, filed on Jan. 25, 2023.

(51) Int. Cl. G08B 21/02

(52) U.S. Cl. CPC G08B 21/02

(57) ABSTRACT

A personal security system for alerting an individual to a potential threat includes a central processing unit (CPU) configured for analyzing input signals from a threat detection sensor and determining a potential threat level. The CPU provides output signals via a user interface alerting the individual to the presence of a potential threat, thus facilitating evasion or responsive countermeasures to the threat.

### CROSS-REFERENCE TO RELATED APPLICATIONS

This application claims priority in U.S. Provisional Patent Application Ser. No. 63/441,102, filed Jan. 25, 2023, all of which are incorporated herein by reference in their entireties.

### BACKGROUND OF THE INVENTION

### 1. Field of the Invention

The present invention relates generally to personal security and protection, and in particular to a wearable device for electronically warning the wearer of an approaching, potential threat detected by a transmission from the device.

### 2. Description of the Related Art

Personal security devices for alerting users to potential threats are currently available. For example, threat-warning audible signals can be activated on “smart” devices, including mobile telecommunications systems. The signals can be heard by users through headphones and earbuds.

Heretofore there has not been available a system or method for warning users of approaching threats comprising individuals and objects with the advantages and features of the present invention.

### BRIEF SUMMARY OF THE INVENTION

In the practice of the personal security system of the present invention, a sensor is provided for detecting a potential threat with sonar, infrared, or ultrasound signal transmissions. The sensor can be conveniently worn or attached to clothing. Upon detection of a potential threat in proximity to the user, a vibrating bracelet, wristband or other receiver is activated to alert the user.

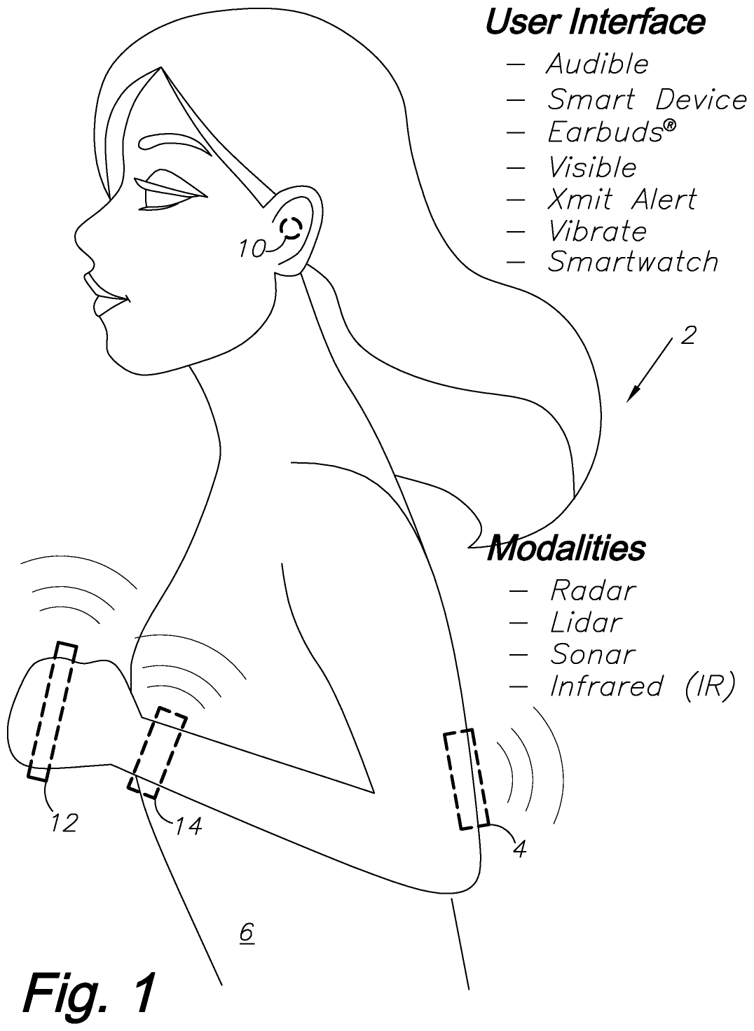

FIG. 1 shows an exemplary application of the personal security system, without limitation, as a radar sensor worn by a runner.

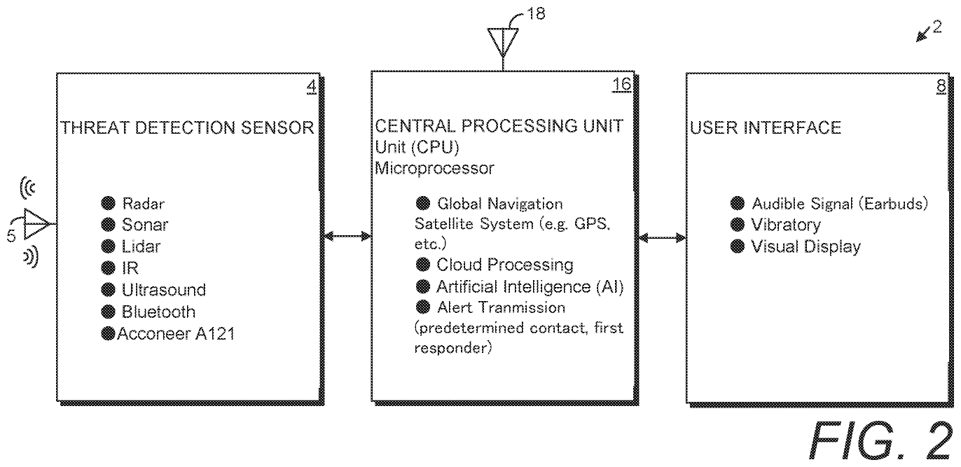

FIG. 2 is a conceptual, block diagram of the major components of the security system.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Proximity Sensor Threat Warning Personal Security System 2

In the practice of the present invention, a personal security system 2 includes a sensor 4 with an antenna 5 and configured for wearing on or in close association with an individual. For example, and without limitation, the sensor 4 can comprise an Acconeer® A121 pulsed coherent radar sensor, which is available from Acconeer AB, San Jose, California. Worn on the back of a runner 6, the sensor is configured for detecting a potential threat approaching from the rear. Using available radar technology, the sensor 2 can analyze range, direction and rate of travel for an approaching threat.

Threat detection results in a warning alert signal transmission to the runner 6 via a user interface 8, which can include a vibratory mechanism, an audio alarm, a visual alarm (such as a flashing light) or a transmission to a first responder and/or a device carried by the runner 6. For example, the runner can wear headphones, such as Earbuds® audio earplugs 10. The user interface can also include a Bluetooth®-enabled personal communications device (cell phone) 12, which can be carried by the runner 6. A wristwatch configuration device is shown at 14 and can be configured with the necessary functionality to receive threat warning signals and communicate same to the runner 6 via sound, light, and touch sensory mechanisms and modalities. The sensor 4 can be mounted on or incorporated in a vest, belt, sports bra, waistband, etc. It can be worn over or under apparel, such as a jacket, hoodie, tracksuit, etc. It can also be incorporated in a smartwatch, a tablet, an iPad®, etc.

A central processing unit (CPU) 16 with an antenna or antennae 18 can include features and functions optimizing the personal security of a user. For example, a global navigation satellite system (GNSS) tracking and positioning component can be included. The dominant GNSS system maintained and operated by the United States Air Force is the Global Positioning System (GPS). Other satellite-based navigation systems are maintained and operated by other countries.

The personal proximity warning device would be used for personal safety and extra awareness. The sensor 4 can consist of a small sensor approximately 1½″ wide by 1″ long by 1″ tall. It can have a clip that could be removed and replaced by a different clip depending on where it would be mounted. Preferably, the sensor 4 is oriented rearwardly on an individual. Without limitation, it could be worn on the back of a hat, running belt, water pack, waistline, or a purse strap. A wristwatch or bracelet 14 can be a basic hook-and-loop (e.g., Velcro®) fastener bracelet with a small plastic housing, roughly the size of a watch. Emergency contact information can be printed on the outside of the housing. Many runners wear similar bracelets for accidents and other medical emergencies.

The system 2 can be configured with 2 RF transceivers, 2 microcontrollers, and a DC vibrating motor (similar to what is in watches and phones). The sensor can utilize radar, sonar, lidar, ultrasound or infrared triangulation. ToF (time of flight) sensor measurements can be utilized for direction, range and acceleration input data for processing by the CPU 16 and analyzing threat levels. For example, a large, fast-approaching object could be a vehicle or a perpetrator associated with relatively high threat levels. The wearer would then take appropriate action to avoid or neutralize the threat.

By contrast, a small or slowly-approaching object detection might indicate a relatively low threat level, such as another jogger for an acquaintance. The CPU 16 can be programmable for adjusting sensitivity to various input signals. A contestant in a marathon could adjust the system to ignore other runners by returning a “0” threat signal, but return a “1” threat signal in response to a fast-approaching vehicle.

### III. Proximity Sensor Threat Warning Personal Security Method

In the practice of the method of the present invention, personal security can be enhanced for anyone walking, jogging, running or just walking to or from their car in a situation that makes them feel unsafe. The system 2 would detect if someone or something was approaching them from behind. This could be a fellow runner or biker or someone trying to sneak up on them. Moreover, “situational awareness” is helpful to prevent individuals from being startled by unexpected, individuals, animals, vehicles, etc. For example, walkers and runners can benefit from awareness of other individuals and vehicles approaching from behind. Still further, “surprise attacks” from behind by perpetrators can be avoided. The intended targets of such attacks can respond appropriately by summoning help, takin evasive action or employing self-defense techniques. The method further includes reprogramming a smart device, e.g., a cell phone, tablet, smartwatch, etc. to automatically summon help in the event of a threatening situation, or an attack. The GNSS component would transmit the location of the system to facilitate prompt assistance.

Triangulation works well with the present system, but other processes such as the ToF potentially could include a broader range. The sensor will continuously emit an IR beam every ½ sec. When nothing is there it will register 0 and nothing will happen. When an object appears, the beam will reflect and return to the sensor measuring distance. If the distance is 0 or increasing the mictrocontroller will do nothing. However, after 3 consecutive decreasing measurements, the controller will power the RF transceiver to send a signal to the RF transceiver in the bracelet. When the bracelet receives the signal, that microcontroller will be programmed to power the pin that is connected to the motor and it will vibrate. This will last up to 2 or 3 seconds or as long as something is approaching.

The vibration will alert the person of someone approaching them silently. This range will likely be around 10-15 feet. This should give the person enough time to turn around and react accordingly.

An advantage of the present invention is that it does not use a camera, nor does it necessarily communicate with a mobile telephone. Therefore, a cell phone and ear buds are not required. Also, the present invention can utilize an IR distance measurement sensor instead of a radar-based sensor for simplification and cost-effectiveness.

The signals utilized by the present invention can comprise sonar, lidar, infrared (IR), ultrasound, etc. Bluetooth® signals can also be utilized.

### IV. Conclusion

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A personal security system configured for wearing by or association with an individual, which system includes:
a central processing unit (CPU);
a threat detection sensor configured for providing an output signal to said CPU corresponding to a detected threat;
a user interface configured for signaling the individual of a detected threat; and
said CPU configured for analyzing threat detection sensor signals and identifying potential threats to the individual based on: size, rate of closure, direction of travel and proximity.

2. The personal security system according to claim 1, which includes:
said threat detection sensor utilizing one or more of the modalities, consisting of: radar, sonar, lidar, ultrasound, Bluetooth and infrared (IR).

3. The personal security system according to claim 2, which includes:
said CPU configured for cloud processing via the Internet worldwide web.

4. The personal security system according to claim 2, which includes:
said CPU including a global navigation satellite system (GNSS) positioning capability.

5. The personal security system according to claim 2, wherein said CPU is configured for artificial intelligence (AI) processing.

6. The personal security system according to claim 1, wherein said user interface is configured for transmitting a threat warning signal to an individual utilizing one or more of: audible signals; visual signals and vibration.

7. A personal security system configured for wearing by or association with an individual, which system includes:
a central processing unit (CPU) including: a Global Navigation Satellite System (GNSS) component configured for providing an output signal corresponding to a location of the individual; a threat level analysis subsystem utilizing one or more of potential threat size, speed, direction and rate-of-closure;
said CPU including an antenna configured for transmitting and receiving signals corresponding to potential threats;
a threat detection sensor configured for transmitting a wireless signal to a potential threat and receiving a wireless signal representing size, direction, rate of closure and speed;
said threat detection sensor including an antenna configured for transmitting and receiving signals corresponding to potential threats.
said threat detection sensor including first and second transmitters and receivers positioned in spaced relation and configured for transmitting wireless signals to a potential threat and receiving wireless signals from a potential threat;
said CPU configured for analyzing time-of-flight (TOF) for said wireless signals and determining direction, speed and rate of closure for a potential threat;
a user interface connected to said CPU and configured for outputting a threat alert signal to the individual comprising one or more of and audible signal, a visual signal or a vibratory signal; and
said CPU including an alert transmission component configured for transmitting a threat signal and a GNSS-defined individual location to a first responder.

8. A method of warning an individual of threat proximity, which includes the steps of:
providing a central processing unit CPU configured for wearing on or association with the individual;
providing a threat detection sensor configured for providing an output signal to said CPU corresponding to a detected threat;
providing a user interface configured for signaling the individual of a detected threat; and
configuring said CPU for analyzing threat detection sensor signals and identifying potential threats to the individual based on: size, rate of closure, direction of travel and proximity.
